(19) United States
(12) Patent Application Publication
(10) Pub. No.: US 2013/0215465 A1
(43) Pub. Date: Aug. 22, 2013

(54) MANAGEMENT SYSTEM, IMAGE FORMING APPARATUS, AND CONTROL METHOD FOR GROUPING INFORMATION OUTPUT FROM AN IMAGE FORMING APPARATUS

(71) Applicant: Canon Kabushiki Kaisha, (US)

(72) Inventors: Masahiro Mutsuno, Tokyo (JP); Tsutomu Kubota, Kawasaki-shi (JP)

(73) Assignee: CANON KABUSHIKI KAISHA, Tokyo (JP)

(21) Appl. No.: 13/766,645

(22) Filed: Feb. 13, 2013

(30) Foreign Application Priority Data
Feb. 21, 2012 (JP) 2012-034693

(51) Int. Cl. G06F 3/12

(52) U.S. Cl. CPC G06F 3/1293
USPC 358/1.15

(57) ABSTRACT

An image forming apparatus acquires an event thereof, determines one or a plurality of output targets to which data according to the event is output, based on a type of the event, and posts a message corresponding to data based on a type of the event on a short sentence communication service by using a plurality of accounts of the short sentence communication service provided by a server as an output target. If an information processing terminal logs in the short sentence communication service by using an account for following a necessary account among the plurality of accounts of the image forming apparatus, the information processing terminal displays messages posted by the image forming apparatus via the followed account.

### BACKGROUND OF THE INVENTION

1. Field of the Invention

The present invention relates to management of image forming apparatuses.

2. Description of the Related Art

With recent advances of mobile devices as typified by smartphones, new information outgoing services have been developed. One such example is a short sentence communication service (also referred to as a simple blog service) called Twitter (registered trademark of Twitter, Inc.), in which each user can post a message (a tweet) within 140 characters.

Meanwhile, mobile devices include a function of acquiring information about the position thereof via a global positioning system (GPS). There is a service that combines such positional information acquisition function and information posted through the above short sentence communication service and that displays the combined information. For example, Sekai Camera (registered trademark of Tonchidot Corporation) superimposes information about captured targets or positions on an image captured by a camera of an information processing terminal such as a smartphone. In this way, augmented reality is expressed, and viewers can feel as if tags were attached to the targets or positions.

In addition, Japanese Patent Application Laid-Open No. 2010-219879 discusses a technique for superimposing help information acquired from a help server on an image of a multi-function printer captured by an information terminal such as a mobile device.

It is conceivable that such short sentence communication service typified by Twitter will be used by image forming apparatuses in the future. However, in the short sentence communication service, information is open to any members. Thus, for managers, customer engineers, and servicemen of an image forming apparatus to share information about the image forming apparatus and manage the image forming apparatus efficiently, for example, it is necessary to group information posted on the short sentence communication service, according to the content.

### SUMMARY OF THE INVENTION

The present invention provides a mechanism for grouping information output from an image forming apparatus depending on the type, to enable users, managers, and servicemen to easily manage the image forming apparatus.

The present invention is directed to a management system in which a server apparatus and an image forming apparatus can communicate with each other. The server apparatus can provide an information service of managing posted messages per account and displaying messages posted by using other associated accounts on an account-specific browse page browsable by an information processing apparatus. The image forming apparatus includes an acquisition unit acquiring apparatus information indicating information or a state about the image forming apparatus, a determination unit determining one or a plurality of output targets to which data according to the apparatus information is output based on a type of the apparatus information acquired by the acquisition unit, and an output unit posting a message based on the apparatus information on the information service by using one or a plurality of accounts of the information service corresponding to the one or plurality of output targets determined by the determination unit.

Further features and aspects of the present invention will become apparent from the following detailed description of exemplary embodiments with reference to the attached drawings.

### BRIEF DESCRIPTION OF THE DRAWINGS

The accompanying drawings, which are incorporated in and constitute a part of the specification, illustrate exemplary embodiments, features, and aspects of the invention and, together with the description, serve to explain the principles of the invention.

FIG. 1 illustrates an overall configuration of a management system including an image forming apparatus according to a first exemplary embodiment of the present invention.

FIG. 2 is a block diagram illustrating an internal configuration of the image forming apparatus in FIG. 1.

FIG. 3 is a block diagram illustrating an internal configuration of a server in FIG. 1.

FIG. 4 is a block diagram illustrating an internal configuration of an information processing terminal in FIG. 1.

FIGS. 5A and 5B illustrate exterior appearance of the information processing terminal.

FIG. 6 is a flow chart illustrating an overall flow of processing executed in the system according to the first exemplary embodiment.

FIG. 7 is a flow chart illustrating an information delivery process according to the first exemplary embodiment.

FIG. 8 illustrates a setting for delivering detection target event information (detection target event delivery setting) according to the first exemplary embodiment.

FIG. 9 illustrates a format of delivery data generated in step S706 (data generation step) in FIG. 7.

FIG. 10 illustrates delivery data delivered from the image forming apparatus to a delivery destination.

FIG. 11 illustrates delivery data delivered from the image forming apparatus to a delivery destination.

FIG. 12 illustrates an overall configuration of a management system including an image forming apparatus according to a second exemplary embodiment of the present invention.

FIG. 13 is a flow chart illustrating an information delivery process according to the second exemplary embodiment.

FIG. 14 illustrates a setting for delivering detection target event information according to the second exemplary embodiment.

FIG. 15 illustrates delivery data delivered from the image forming apparatus to a delivery destination in step S1304 in FIG. 13.

FIG. 16 is a flow chart illustrating an information reception process according to the present invention.

FIG. 17 illustrates a preset command table.

### DESCRIPTION OF THE EMBODIMENTS

Various exemplary embodiments, features, and aspects of the invention will be described in detail below with reference to the drawings.

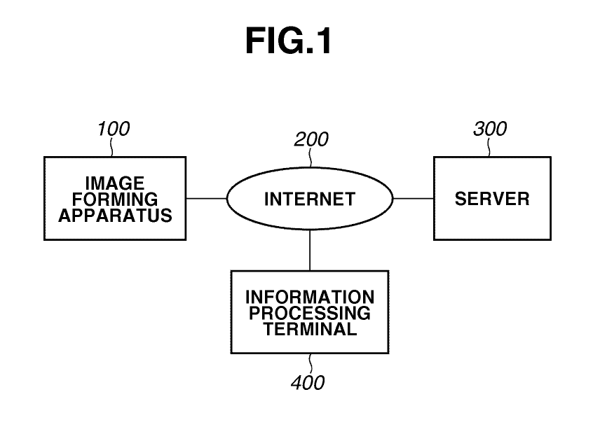

The present invention is not limited to any configurations described in the following exemplary embodiments.

<Print system configuration> Hereinafter, a system configuration according to a first exemplary embodiment of the present invention will be described with reference to FIG. 1. FIG. 1 illustrates an overall configuration of a management system including an image forming apparatus according to the first exemplary embodiment of the present invention. As illustrated in FIG. 1, the system according to the first exemplary embodiment includes an image forming apparatus 100, a server 300, and an information processing terminal 400 that can communicate with each other via an Internet 200. An Internet Protocol (IP) address for identifying a device via the network 200 is allocated to each of the components (the image forming apparatus 100, the server 300, and the information processing terminal 400).

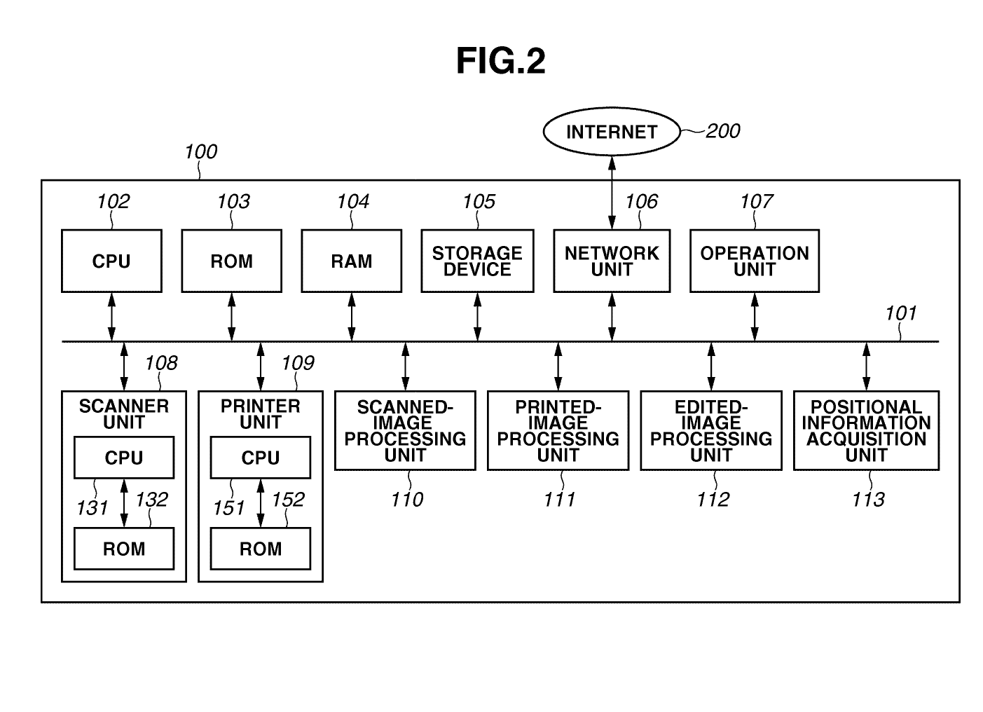

FIG. 2 is a block diagram illustrating an internal configuration of the image forming apparatus 100 in FIG. 1. As illustrated in FIG. 2, the units in the image forming apparatus 100 are electrically connected to each other via a system bus 101. A central processing unit (CPU) 102 controls the entire image forming apparatus. A read-only memory (ROM) 103 stores a program that is executed when the CPU 102 starts the image forming apparatus 100. A random access memory (RAM) 104 is a work memory for temporarily storing data used by the CPU 102 for calculation.

A storage device 105 is formed by a hard disk drive (HDD), a solid state drive (SSD), or the like. The storage device 105 stores software relating to control of the image forming apparatus 100, various settings, and data such as documents and images, for example.

A network unit 106 serves as an interface to the Internet 200 and exchanges information with other information devices via the Internet 200. An operation unit 107 controls input of an operation from a user and display of information to a user. For example, the operation unit 107 includes a liquid crystal operation panel including liquid crystal and a touch panel and hard keys.

A scanner unit 108 is configured to read a document and includes an illumination lamp, a scanning mirror, and so forth (not illustrated). A printer unit 109 is configured to execute printing on a recording sheet such as paper and includes a photosensitive drum or a fixing device (not illustrated) for forming and fixing an image.

The scanner unit 108 includes a CPU 131 and a ROM 132. The CPU 131 executes processing based on programs stored in the ROM 132. In addition, the CPU 131 communicates with the CPU 102 on an as-needed basis and controls the scanner unit 108 in accordance with instructions from the CPU 102. For example, a normal operation management program, a power state management program, an error management program, and a service information management program are operated by the CPU 131 of the scanner unit 108. With these programs, more detailed control and management operations are executed, such as reading a document.

The CPU 131 of the scanner unit 108 notifies the CPU 102 of various types of event information detected by execution of a program. In addition, the CPU 131 can notify the CPU 102 of such event information in response to a request from the CPU 102. Examples of the event information of which the CPU 131 notifies the CPU 102 include document information, power control information, job execution information, and error information (a document jam, an abnormal operation, etc.).

Similarly, the printer unit 109 includes a CPU 151 and a ROM 152. The CPU 151 executes processing based on programs stored in the ROM 152. In addition, the CPU 151 communicates with the CPU 102 on an as-needed basis and controls the printer unit 109 in accordance with instructions from the CPU 102. For example, a normal operation management program, a power state management program, an error management program, and a service information management program are operated by the CPU 151 of the printer unit 109. With these programs, more detailed control and management operations are executed, such as printing a sheet.

The CPU 151 of the printer unit 109 notifies the CPU 102 of various types of event information detected by execution of a program. In addition, the CPU 151 can notify the CPU 102 of such event information in response to a request from the CPU 102. Examples of the event information of which the CPU 131 notifies the CPU 102 include sheet information, power control information, job execution information, and error information (a paper jam, no toner, an abnormal temperature, an abnormal operation, etc.).

A scanned-image processing unit 110 and a printed-image processing unit 111 execute image processing. For example, these scanned- and printed-image processing units 110 and 111 correct, process, or convert image data that has been supplied from the scanner unit 108 and that is to be output (for printing) to the printer unit 109. An edited-image processing unit 112 rotates image data or executes image compression/decompression processing based on Joint Photographic Experts Group (JPEG), Joint Bi-level Image Experts Group (JBIG), Modified Modified Read (MMR), or Modified Huffman (MH).

A positional information acquisition unit 113 includes a sensor for detecting longitude, latitude, and altitude information and acquires positional information about the image forming apparatus 100. The CPU 102 can access a map information server (not illustrated) via the Internet and use the positional information acquired from the positional information acquisition unit 113 to acquire a geographical name (address).

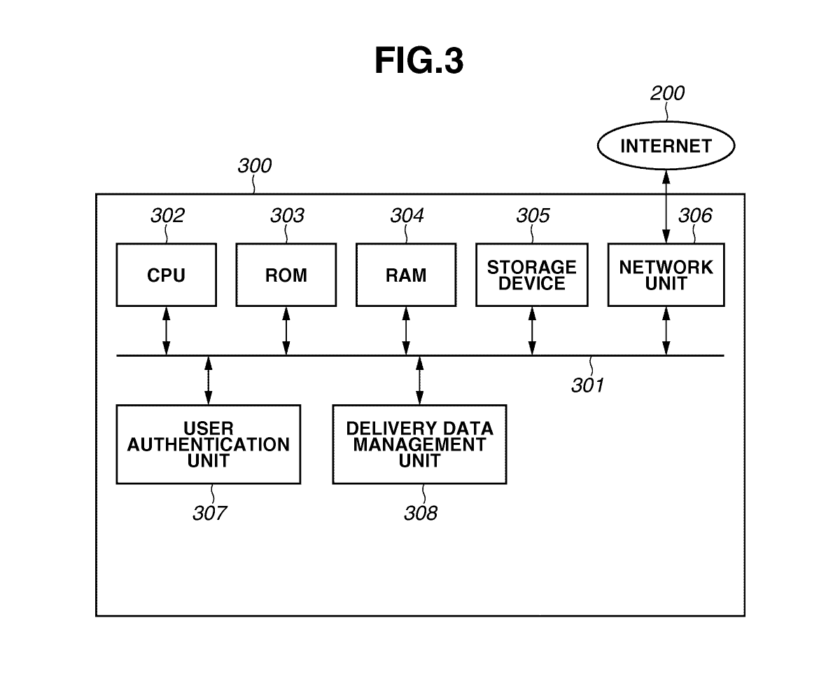

FIG. 3 is a block diagram illustrating an internal configuration of the server 300 in FIG. 1. As illustrated in FIG. 3, the units in the server 300 are electrically connected to each other via a system bus 301. A CPU 302 controls the entire server 300. A ROM 303 stores a program that is executed when the CPU 302 starts the server 300. A RAM 304 is a work memory for temporarily storing data used by the CPU 302 for calculation.

A storage device 305 is formed by an HDD, an SSD, or the like. The storage device 305 stores programs, various data, and the like used by the server 300. In addition, the storage device 305 stores data delivered from the image forming apparatus 100 via the Internet 200.

A network unit 306 serves as an interface to the Internet 200 and exchanges information with other information devices via the Internet 200. A user authentication unit 307 authenticates a user who logs in the server 300. For example, when a user causes the image forming apparatus 100 to deliver information, the user first logs in the server 300. A delivery data management unit 308 manages data delivered (posted) by the image forming apparatus 100. For example, the delivery data management unit 308 associates user names with delivery data and sets browse authority per user name.

The user authentication unit 307 and the delivery data management unit 308 are software modules that can be realized by causing the CPU 302 to read and execute a computer-readable program recorded in the storage device 305.

The CPU 302 uses various functions realized by using the user authentication unit 307 and the delivery data management unit 308 and by executing other programs stored in the storage device 305, to provide a short sentence communication service (simple blog service) such as Twitter (registered trademark) or Chatter (registered trademark). Namely, the server 300 serves to provide a short sentence communication service.

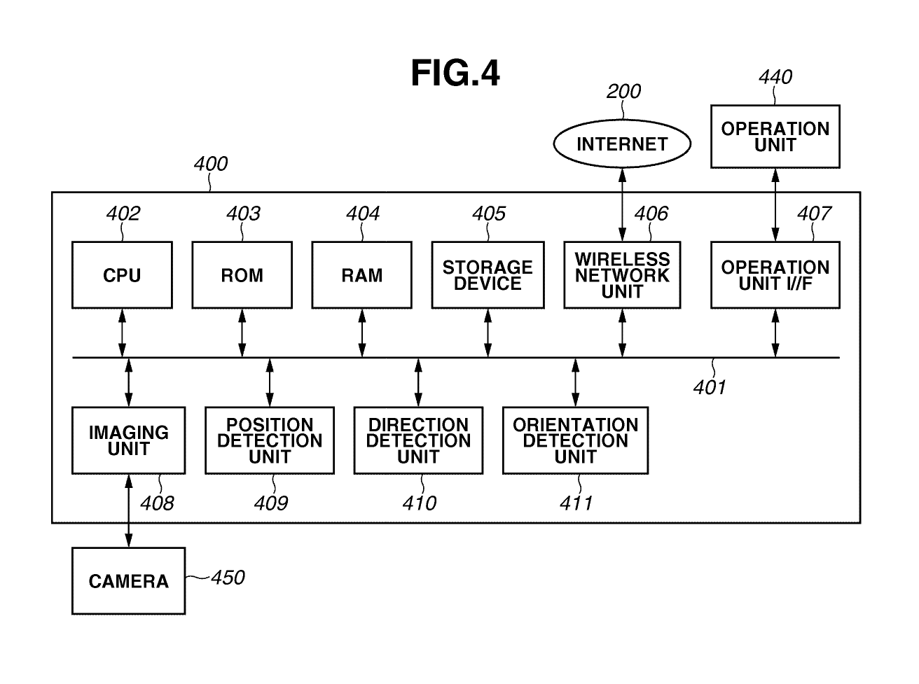

FIG. 4 is a block diagram illustrating an internal configuration of the information processing terminal 400 in FIG. 1. As illustrated in FIG. 4, the units in the information processing terminal 400 are electrically connected to each other via a system bus 401. A CPU 402 controls the entire information processing terminal 400. A ROM 4 03 stores a program that is executed when the CPU 402 starts the information processing terminal 400. A RAM 404 is a work memory for temporarily storing data used by the CPU 402 for calculation. A storage device 405 is formed by a flash ROM or the like and stores programs and various data used by the CPU 402.

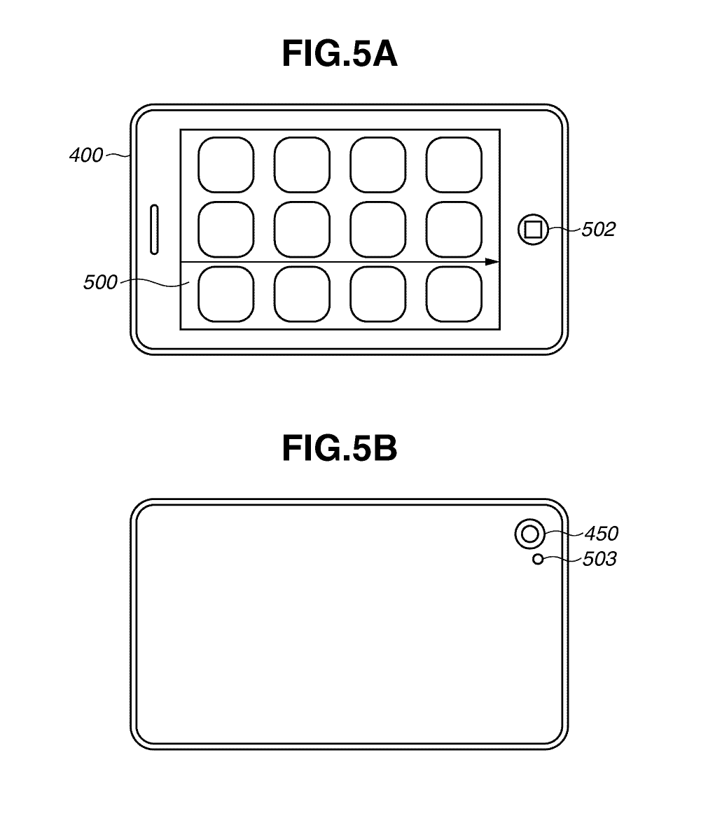

A wireless network unit 406 is an interface for communication with the Internet 200 via wireless communication such as a wireless local area network (LAN) or a mobile telephone network. An operation unit interface (I/F) 407 uses an operation unit 440 (including a touch panel 501, a home button 502, etc. in FIG. 5) to exchange information between a user and the information processing terminal 400. An imaging unit 408 uses a camera 450 to capture an image.

A position detection unit 409 uses a GPS receiver or the like to determine the current position of the information processing terminal 400. A direction detection unit 410 uses a geomagnetic sensor or the like to detect the direction which the information processing terminal 400 currently faces. An orientation detection unit 411 uses an acceleration sensor or the like to determine whether the user is holding the information processing terminal 400 vertically or horizontally.

FIGS. 5A and 5B illustrate exterior appearance of the information processing terminal 400. More specifically, FIG. 5A illustrates appearance of the front side of the information processing terminal 400. The touch panel 501 is a liquid crystal touch panel displaying information to the user and receiving input from the user. The touch panel 501 can detect the duration of time a user touches the touch panel 501 when inputting information. Namely, the touch panel 501 can distinguish a normal tap (press) from a long tap (press and hold). The home button 502 is used to cancel an application being executed and return to a home screen.

FIG. 5B illustrates exterior appearance of the back side of the information processing terminal 400. The camera 450 captures an image, and a flash 503 assists imaging executed by the camera 450.

While a smartphone is illustrated in FIGS. 4, 5A, and 5B as an example of the information processing terminal 400, the information processing terminal 400 may be a personal computer (PC), a tablet computer, or the like. The information processing terminal 400 may be an arbitrary information processing apparatus, as long as the information processing apparatus can use a service provided by the server 300.

### Overall System Flow

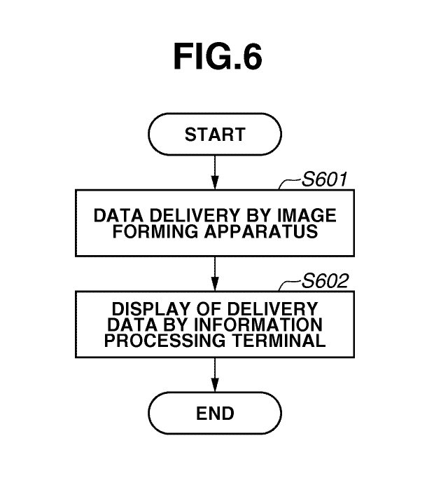

FIG. 6 is a flow chart illustrating an overall flow of processing executed in the system according to the first exemplary embodiment. In this flow, the image forming apparatus 100 delivers data based on a state of the apparatus, to the server 300 and the information processing terminal 400 acquires the data of the image forming apparatus 100 from the server 300.

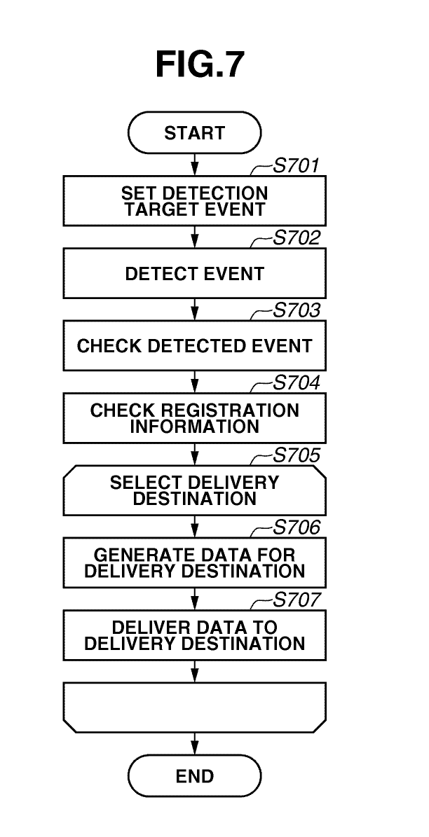

First, in step S601, the image forming apparatus 100 delivers data to the server 300. Based on a state of the image forming apparatus 100, the image forming apparatus 100 creates delivery data and delivers the data to the server 300 via the network (posts the data on a short sentence communication service provided by the server 300). Step S601 will be described in detail with reference to FIG. 7 below.

Next, in step S602, the information processing terminal 400 acquires the delivery data of the image forming apparatus 100 from the server 300 and displays the delivery data. The information processing terminal 400 can receive the data delivered from the image forming apparatus 100 to the server 300 by accessing the server 300 and can display the delivery data based on display software in the information processing terminal 400. The information processing terminal 400 can display the delivery data while sequentially exchanging necessary data with the server 300.

The delivery data can be displayed on the information processing terminal 400 in various methods. In one method (first display method), the delivery data is displayed chronologically (timeline display). In another method (second display method), positional information about the delivered information is used, and the delivery data is superimposed on map data. In still another method (third display method), the delivery data is superimposed on an image captured by the camera 450 of the information processing terminal 400. More specifically, in the third display method, by superimposing the delivery data on an image captured by the camera 450 of the information processing terminal 400, augmented reality is a display means of expression as if tags (air tags) were attached to captured objects or positions. Step S602 will be described in detail below.

According to the present invention, since the image forming apparatus 100 delivers data based on a state thereof, a user receiving the delivery data can grasp the apparatus state more easily. In addition, by adding information (a name, positional information, an address, etc., as will be described in detail below) about the image forming apparatus 100 to the delivery data, a user can more easily distinguish and find the image forming apparatus 100 corresponding to the delivery data.

### Data Delivery Flow

Next, a method for creating delivery data and delivering the delivery data according to the present invention will be described. FIG. 7 is a flow chart illustrating an information delivery process according to the first exemplary embodiment. Each of the steps in the flow chart in FIG. 7 is realized by causing the CPU 102 of the image forming apparatus 100 to execute a computer-readable program recorded in the storage device 105.

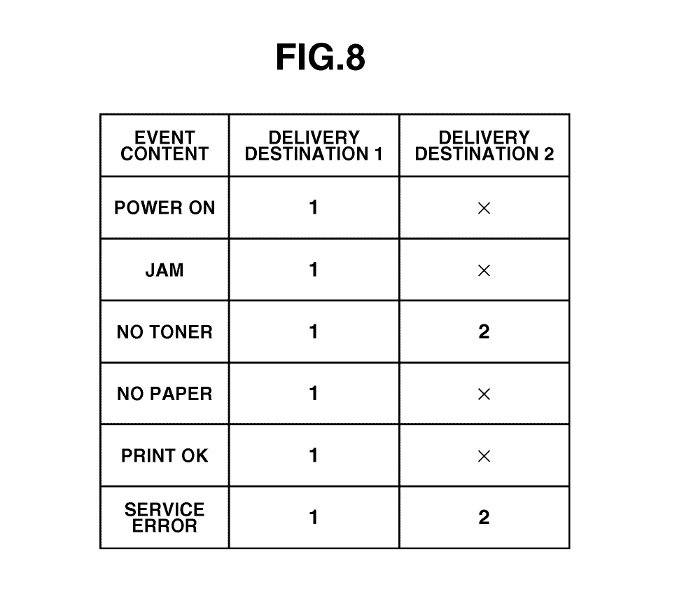

First, in step S701 (detection target event setting step), the CPU 102 executes setting and registration for detecting an event occurring in the image forming apparatus 100 and delivering information about the detection target event (see FIG. 8, for example).

For example, events such as “power on/off,” “switching to/returning from power-saving mode,” “occurrence of/recovery from j am, ” “out of toner/recovery from out of toner,” “out of paper/recovery from out of paper,” or “service error” can be set. If any one of such set events is caused, the CPU 102 delivers data to a certain destination. The delivery data transmission destination and positional information about the image forming apparatus 100 are also set in this step. The data is set by selecting and specifying setting items displayed on the operation unit 107. Alternatively, setting items can be set via the network unit 106 through the Internet 200.

FIG. 8 illustrates a setting (detection target event delivery setting) for delivering detection target event information according to the first exemplary embodiment. In the detection target event delivery setting according to the first exemplary embodiment, the CPU 102 examines a detection target event and determines whether to deliver the detection target event to a corresponding delivery destination. In addition, when detection target events are set, delivery data levels can be set. Delivery contents can be changed depending on the delivery data levels. Namely, in the detection target event delivery setting, at least one event content to be detected is set, and a delivery destination (output target) and a delivery data level are set for each event content set (namely, for each type of apparatus information about the image forming apparatus).

FIG. 8 illustrates delivered event contents and a pair of delivery destinations. In the columns of the delivery destinations, numbers are indicated as information specifying the delivery data levels. A symbol “x” is indicated as information specifying a delivery destination to which corresponding delivered event content is not delivered.

More specifically, according to the setting in FIG. 8, if the CPU 102 detects any of the event contents “POWER ON,” “JAM,” “NO TONER,” “NO PAPER,” “PRINT OK,” and “SERVICE ERROR” (including an error of a fixing device, an error of a transfer belt, etc.), the CPU 102 delivers delivery data to delivery destination 1 at level “1”. The CPU 102 delivers delivery data to delivery destination 2 at level “2” only when the CPU 102 detects the event content “NO TONER” or “SERVICE ERROR.”

By recording the setting in the storage device 105, the setting is registered in the image forming apparatus 100. When the CPU 102 executes the information delivery process (FIG. 7), the setting is loaded from the storage device 105 to the RAM 104. In this way, the processing speed is increased.

The CPU 102 executes the detection target event setting and registration process in step S701 only when a detection target event or a delivery destination is not registered or when an instruction for re-registering a detection target event or a delivery destination is input. If detection target events and delivery destinations have already been registered and there is no instruction for re-registration, the CPU 102 causes the operation to skip step S701 and proceed to step S702.

In the first exemplary embodiment, since the CPU 102 posts data on the short sentence communication service, the CPU 102 sets account information (a user name, a password, etc.) of the short sentence communication service as a delivery destination. For example, delivery destination 1 is set as an account for a general user and delivery destination 2 for a serviceman. The number of delivery destinations is not limited to two. One delivery destination or three or more delivery destinations may be set.

In the first exemplary embodiment, a plurality of delivery destinations is set. This is to group delivery data, by changing delivery destinations or delivery contents depending on an event which occurred. Thus, grouping of delivery data enables general users, managers, customer engineers, and servicemen of an image forming apparatus to share or differentiate information about the image forming apparatus. As a result, the image forming apparatus can be managed efficiently.

In step S702, the CPU 102 waits for detection of an event caused in the image forming apparatus 100. If the CPU 102 detects (acquires) an event, the CPU 102 causes the operation to proceed to step S703. Since event information detected by the scanner unit 108 or the printer unit 109 is transmitted to the CPU 102, the CPU 102 can always monitor an overall state of the image forming apparatus 100.

Next, in step S703, the CPU 102 checks (determines) whether the event detected in step S702 is an event set in step S701. If the CPU 102 determines that the event detected in step S702 is an event set in step S701, the CPU 102 causes the operation to proceed to step S704. If the CPU 102 determines that the event detected in step S702 is not an event set in step S701, the CPU 102 causes the operation to return to step S702 and waits for detection of another event. This loop is not illustrated in the flow chart in FIG. 7.

Next, in step S704 (setting check step), the CPU 102 checks the event detected in step S702 against the registration information (setting in step S701), determines a data delivery destination and a data delivery level, and causes the operation to proceed to step S705. For example, if “JAM” is detected as the event, the CPU 102 determines to deliver data to delivery destination 1 as the delivery destination at level 1. If “NO TONER” is detected as the event, the CPU 102 determines to deliver data to delivery destinations 1 and 2 as the delivery destinations at levels 1 and 2, respectively.

In steps S705 to S707, the CPU 102 delivers data to each of the delivery destinations determined in step S704. In step S705, the CPU 102 determines whether there are any delivery destinations that have not received the data among the delivery destinations determined in step S704. If there are such delivery destinations, the CPU 102 selects one of the delivery destinations as the current delivery destination and causes the operation to proceed to step S706.

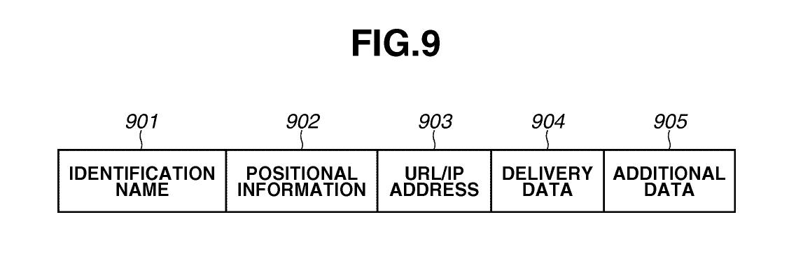

In step S706 (data generation step), the CPU 102 generates delivery data to be delivered to the current delivery destination on the RAM 104. More specifically, the CPU 102 generates delivery data contents based on the event detected in step S702 and the level determined in step S704. Information such as the uniform resource locator (URL) and the current position of the image forming apparatus 100 is added to the delivery data. The current positional information may be input by a user via the operation unit I/F 107 or acquired by a position detection unit such as by GPS. The delivery data will be described below with reference to FIGS. 9 to 11.

Next, in step S707 (data delivery step), the CPU 102 uses an account corresponding to the current delivery destination to deliver the data generated in step S704 to the server 300 via the network unit 106 and the Internet 200. According to the first exemplary embodiment, the account corresponding to the current delivery destination is used to post the data on the short sentence communication service provided by the server 300. Next, the CPU 102 causes the operation to return to step S705.

In step S705, if the CPU 102 determines that there is no delivery destination that has not received the data among the delivery destinations determined in step S704 (if the data has been delivered to all the delivery destinations), the CPU 102 completes the loop of steps S705 to S707. While this loop is not illustrated in the flow chart in FIG. 7, after the loop of steps S705 to S707 is completed, the CPU 102 returns to step S702 and waits for detection of another event caused in the image forming apparatus 100. If the CPU 102 receives an instruction for re-registering a detection target event or a delivery destination, the CPU 102 starts the operation with step S701.

Next, the delivery data generated in step S706 (data generation step) in FIG. 7 will be described in detail with reference to FIGS. 9 to 11. FIG. 9 illustrates a format of the delivery data generated in step S706 (data generation step) in FIG. 7. As illustrated in FIG. 9, the delivery data includes an identification name 901, positional information 902, a URL/IP address 903, delivery data 904, and additional data 905. The identification name 901 is an identifier for distinguishing the image forming apparatus 100. The positional information 902 is information acquired by the positional information acquisition unit 113 in FIG. 2. The positional information 902 may be input by a user via the operation unit I/F 107 or may be acquired by a position detection unit such as by GPS.

The URL/IP address 903 is a URL/IP address used by the network unit 106 in FIG. 2. The delivery data 904 is data created based on the event detected in step S702 in FIG. 7. For example, if the CPU 102 detects an event indicating that there is no cyan toner of model number 10020 (“NO TONER” in the event content column in FIG. 8), the CPU 102 creates data indicating “THERE IS NO TONER” as the delivery data at level 1 and data indicating “THERE IS NO CYAN TONER OF MODEL NUMBER 10020” as the delivery data at level 2. If the CPU 102 detects an event indicating an error relating to a fixing device of model number 30020 (“SERVICE ERROR” event content column in FIG. 8), the CPU 102 creates data indicating “THERE IS ERROR OF FIXING DEVICE” as the delivery data at level 1 and data indicating “THERE IS ERROR OF FIXING DEVICE OF MODEL NUMBER 30020” as the delivery data at level 2, for example.

The additional data 905 is data added to the delivery data, other than the above data. In the first exemplary embodiment, the additional data 905 specifies a user type to which the delivery data is delivered. For example, if the data is delivered to all users, customers, and servicemen, the additional data 905 indicates “ALL,” “CUSTOM,” and “SERVICE,” respectively. By adding such additional data 905 specifying target users, receivers can adjust a response, based on the delivery data.

When the CPU 102 posts data in the format as illustrated in FIG. 9 on the short sentence communication service, for example, the CPU 102 posts the data 901 to 905 in FIG. 9 as text data (by dividing the data with commas or spaces, for example). Alternatively, by storing the data 901 to 905 in FIG. 9 in a storage device of a certain server (in the storage device 305 of the server 300, in a storage device of a server (not illustrated), or in the storage device 105 of the image forming apparatus 100, for example), the URL of the storage device and the delivery data 904 may be posted as text data on the short sentence communication service.

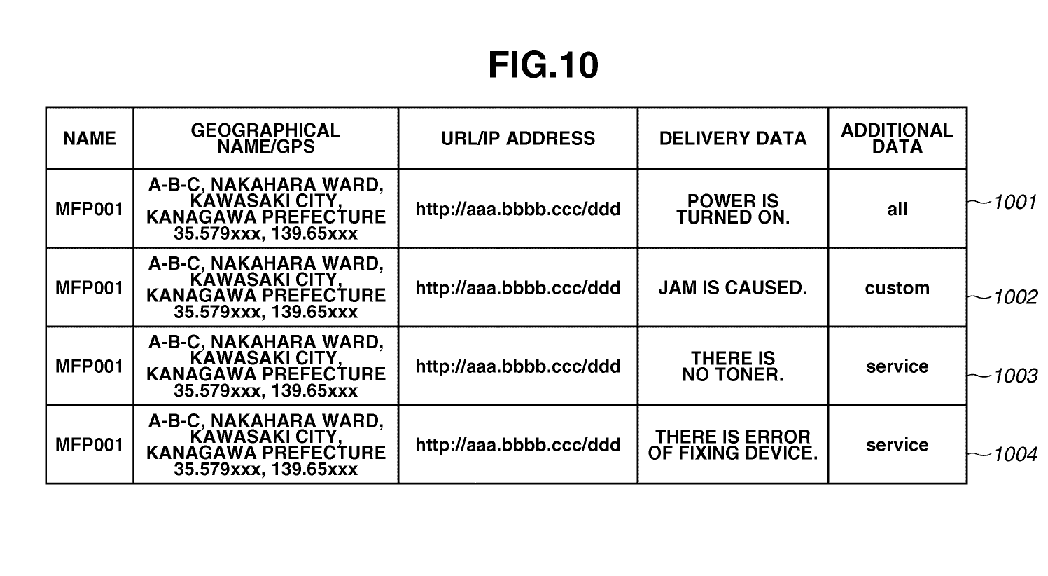

FIG. 10 illustrates one example of delivery data delivered from the image forming apparatus 100 to delivery destination 1. FIG. 10 illustrates sequential delivery of delivery data 1001 to 1004. Each of the delivery data 1001 to 1004 includes the identification name (name) 901, the positional information (geographical name/GPS) 902, the URL/IP address 903, the delivery data 904, and the additional data 905. As illustrated in FIG. 8, since the delivery data to delivery destination 1 is at level 1, the delivery data 904 is data at level 1. Namely, “POWER IS TURNED ON, ” “JAM IS CAUSED, ” “THERE IS NO TONER, ” and “THERE IS ERROR OF FIXING DEVICE” are indicated, for example.

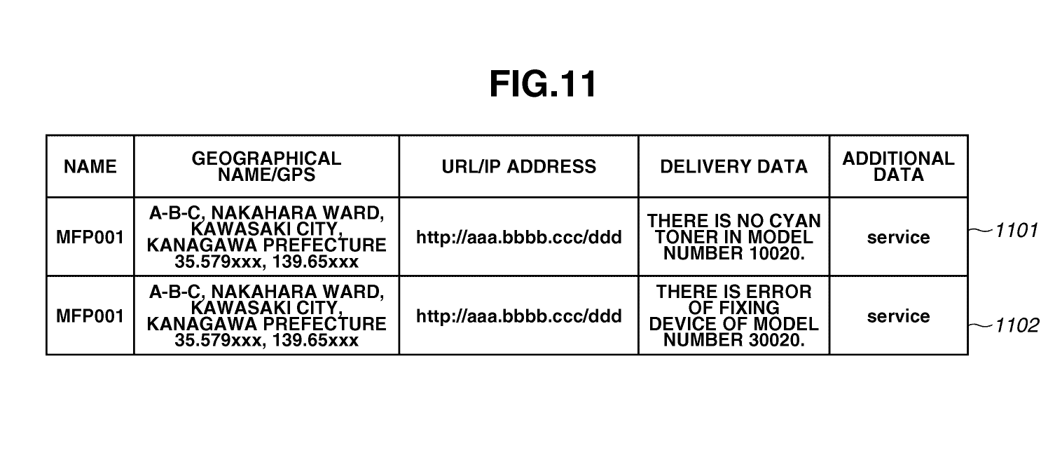

FIG. 11 illustrates one example of delivery data delivered from the image forming apparatus 100 to delivery destination 2. FIG. 11 illustrates sequential delivery of delivery data 1101 and 1102. Each of the delivery data 1101 and 1102 includes the identification name (name) 901, the positional information (geographical name/GPS) 902, the URL/IP address 903, the delivery data 904, and the additional data 905. As illustrated in FIG. 8, since the delivery data to delivery destination 2 is at level 2, the CPU 102 transmits the delivery data including contents different from those of the data at level 1 in FIG. 10. More specifically, as the delivery data 904, the CPU 102 transmits data indicating “THERE IS NO CYAN TONER OF MODEL NUMBER 10020” and “THERE IS ERROR OF FIXING DEVICE OF MODEL NUMBER 30020”, instead of “NO TONER” and “THERE IS ERROR OF FIXING DEVICE” in FIG. 10, respectively.

Next, a delivery data display process executed by the information processing terminal 400 in step S602 in FIG. 6 will be described. The short sentence communication service provided by the server 300 includes a function called “follow.” By using this function called “follow,” a user can display data posted by other users on his/her own page (provided per account). For example, if a user logs in the short sentence communication service via a Web browser or a dedicated application on the information processing terminal 400, the information processing terminal 400 displays a page corresponding to the login account. The user can browse data posted by other following users (followers) on this page.

For example, if he or she wishes to follow a certain user, he or she opens the page of the certain user (for example, “URL http://short sentence communication servicename.com/[user name] ”) and clicks a button “follow” on this page. In this way, he or she can follow this certain user. Once this follower setting is completed, subsequently, data posted by the certain user is displayed on his or her own page. Namely, the server 300 is configured to provide an information service that manages posted messages per account and displays messages posted by using other accounts associated by the above “follow” mechanism on a browse page per account browsable by an information processing apparatus.

In the first exemplary embodiment, data delivered from the image forming apparatus 100 is data posted on the short sentence communication service. Thus, for example, by using the above “follow” mechanism, the data delivered from the image forming apparatus 100 can be displayed on the information processing terminal 400. Namely, if a user wishes to browse the data delivered from the image forming apparatus 100, the user “follows” an account corresponding to delivery destination 1 or 2, depending on the level of information to browse.

In this way, for example, if a user operates the information processing terminal 400 and logs in the short sentence communication service, the data delivered from the image forming apparatus 100 to delivery destination 1 or 2 is chronologically displayed on the user page of a display unit (touch panel 501) of the information processing terminal 400. Thus, the user can browse the delivery data.

The user may be allowed to browse the delivery data, by using a dedicated application of the information processing terminal 400 to log in the short sentence communication service, acquire the positional information 902 included in the delivery data from a follower, and superimpose the delivery data on map data by using the positional information 902. With this display method, the user can determine which image forming apparatus has caused an event more easily. Consequently, the event can be handled more quickly.

Similarly, the user may be allowed to browse the delivery data, by using a dedicated application on the information processing terminal 400 to log in the short sentence communication service, acquire the positional information 902 included in the delivery data from a follower, and superimpose the delivery data on an image captured by the camera 450 of the information processing terminal 400. With this display method, if the user captures an image of the image forming apparatus 100 by using the camera 450 of the information processing terminal 400, augmented reality can be displayed as if a tag indicating the content of the delivery data 904 is attached to the captured image of the image forming apparatus 100.

More specifically, with this display method, the information processing terminal 400 can display an image as if the image forming apparatus 100 itself were saying “NO TONER” or the like. Thus, the user can more easily determine the event caused in the image forming apparatus during capturing an image. Consequently, the event can be handled more quickly. Particularly, if there is a plurality of image forming apparatuses, the user can determine which image forming apparatus has caused the event at a glance.

### Effect of First Exemplary Embodiment

As described above, according to the first exemplary embodiment, since data delivered from the image forming apparatus 100 can be classified into appropriate delivery destinations per event, the delivery data can be grouped. As a result, since users, managers, and servicemen can easily grasp a state per delivery destination, the users, managers, and servicemen can easily manage the image forming apparatus.

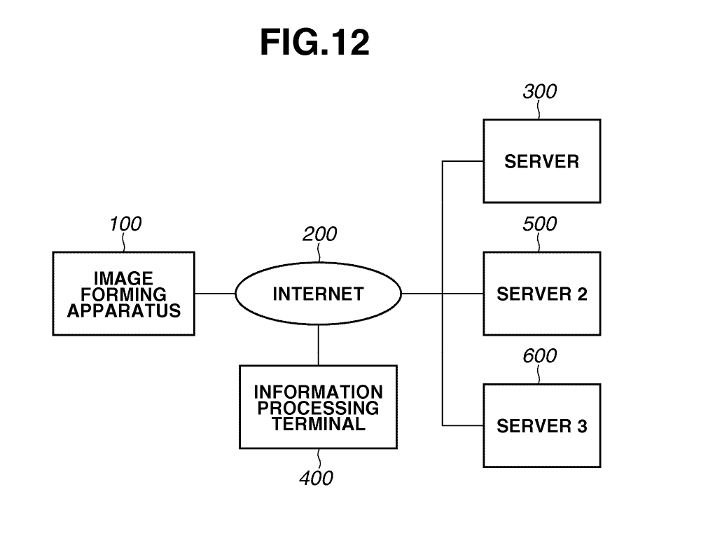

In a second exemplary embodiment, delivery data information is transmitted to a plurality of servers. Next, the difference between the first and second exemplary embodiments will be described. FIG. 12 illustrates an overall configuration of a management system including an image forming apparatus according to the second exemplary embodiment of the present invention. Components in FIG. 12 identical to those in FIG. 1 are denoted by the identical reference characters.

In the system according to the second exemplary embodiment, in addition to the components in FIG. 1, other server apparatuses (server 2 (500) and server 3 (600)) different from the server 300 (first server apparatus) that provides the short sentence communication service are added. The server 2 (500) maybe a server accessed by a protocol different from that used for the server 300. In the second exemplary embodiment, the server 300 is accessed by the http protocol, and the server (500) is accessed by the https protocol.

The server 2 (500) is a server that receives delivery data different from that received by the server 300. For example, the server 2 (500) serves as a monitoring server that receives management information about the image forming apparatus 100. More specifically, for example, the server 2 (500) receives data including operating statuses of the image forming apparatus 100 (consumable supply (toner, paper) remaining amounts, a total print counter value, CO2 emission, power consumption, etc., in addition to various types of error information such as error codes).

The server 2 (500) may include the same data as data that is supplied to the server 300. The server 2 (500) may be a server that executes monitoring by using Simple Network Management Protocol (SNMP). In the second exemplary embodiment, unlike the server 300, the server 2 (500) does not provide the short sentence communication service.

The server 3 (600) is a server that receives data different from the delivery data. For example, the server 3 (600) receives detailed data such as log information. In the second exemplary embodiment, unlike the server 300, the server 3 (600) does not provide the short sentence communication service.

### Data Delivery Flow

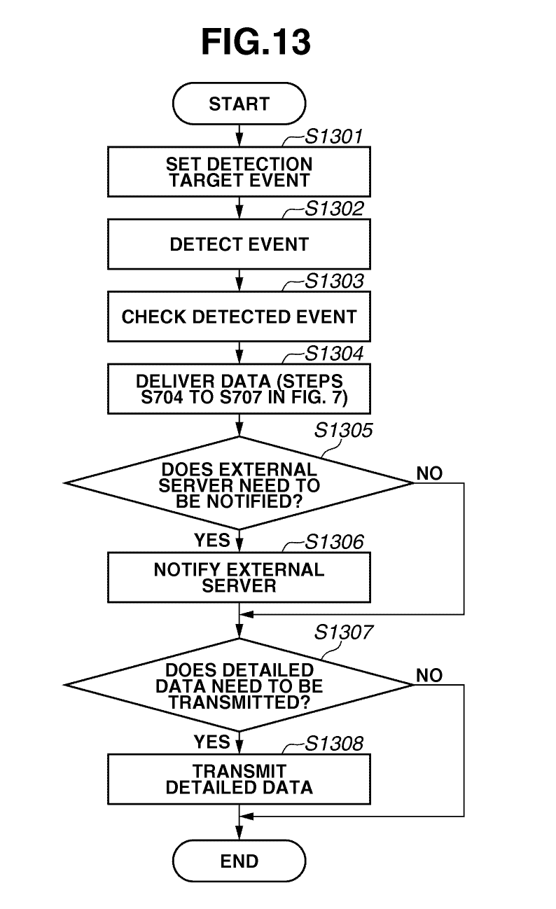

Next, a method for creating delivery data and delivering the data will be described which is a feature of the present invention. FIG. 13 is a flow chart illustrating an information delivery process according to the second exemplary embodiment. Each of the steps in the flow chart in FIG. 13 is realized by causing the CPU 102 of the image forming apparatus 100 to execute a computer-readable program recorded in the storage device 105.

FIG. 13 is a flow chart illustrating an information delivery flow. Each of the steps in the flow chart in FIG. 13 is realized by causing the CPU 102 of the image forming apparatus 100 to execute a program stored in the storage device 105.

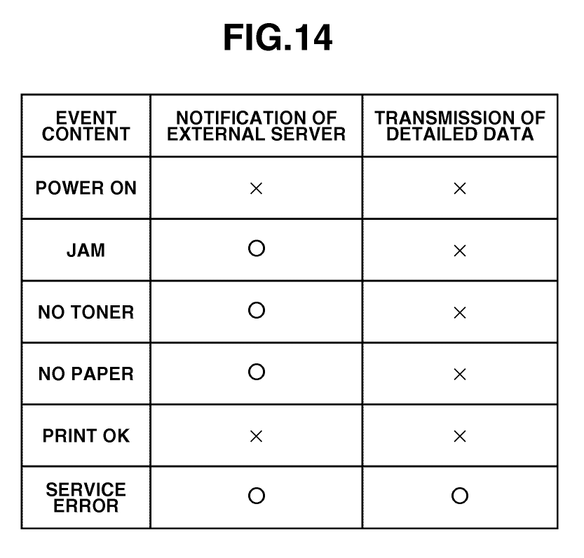

First, in step S1301 (detection target event setting step), the CPU 102 executes setting and registration for detecting an event caused in the image forming apparatus 100 and for delivering information about the detection target event. The same events as those in the first exemplary embodiment can be set. In addition, a setting illustrated in FIG. 14 can be made in the second exemplary embodiment, in addition to the setting illustrated in FIG. 8.

FIG. 14 illustrates an example setting for delivering detection target event information according to the second exemplary embodiment. As illustrated in FIG. 14, in the second exemplary embodiment, whether to notify an external server per event and whether to transmit detailed data to an external server are set. When the external server is notified, it is the server 2 (500) that is notified. When detailed data is transmitted to an external server, it is the server 3 (600) to which the detailed data is transmitted.

In FIG. 14, if the CPU 102 detects “JAM,” “NO TONER,” “NO PAPER, ” and “SERVICE ERROR (including error of fixing device, error of transfer belt, etc.), the CPU 102 determines that the external server (server 2 (500)) needs to be notified. If the CPU 102 detects “SERVICE ERROR,” the CPU 102 determines to transmit detailed data to the external server (server 3 (600)). This setting is recorded in the storage device 105. When the CPU 102 executes the information delivery flow, the setting is loaded from the storage device 105 to the RAM 104. In this way, the processing speed is increased.

In step S1302, the CPU 102 waits for detection of an event caused in the image forming apparatus 100. If the CPU 102 detects (acquires) an event, the CPU 102 causes the operation to proceed to step S1303. Since event information detected by the scanner unit 108 or the printer unit 109 is transmitted to the CPU 102, the CPU 102 can always monitor an overall state of the image forming apparatus 100.

In step S1303, the CPU 102 checks (determines) whether the event detected in step S1302 is an event set in step S1301 (any one of the events set in FIG. 8 or 14).

If the CPU 102 determines that the event detected in step S1302 is an event set in step S1301, the CPU 102 causes the operation to proceed to step S1304. If the CPU 102 determines that the event detected in step S1302 is not an event set in step S1301, the CPU 102 causes the operation to return to step S1302 and waits for detection of another event. This loop is not illustrated in the flow chart in FIG. 13.

In step S1304, the CPU 102 delivers data to the server 300. More specifically, the CPU 102 executes steps S704 to S707 in FIG. 7 to transmit delivery data to the server 300. If the detected event requires that the data also needs to be supplied to external servers, the CPU 102 adds an identifiable ID to the additional data 905 so that data transmitted insteps S1306 and S1308 is matched (associated).

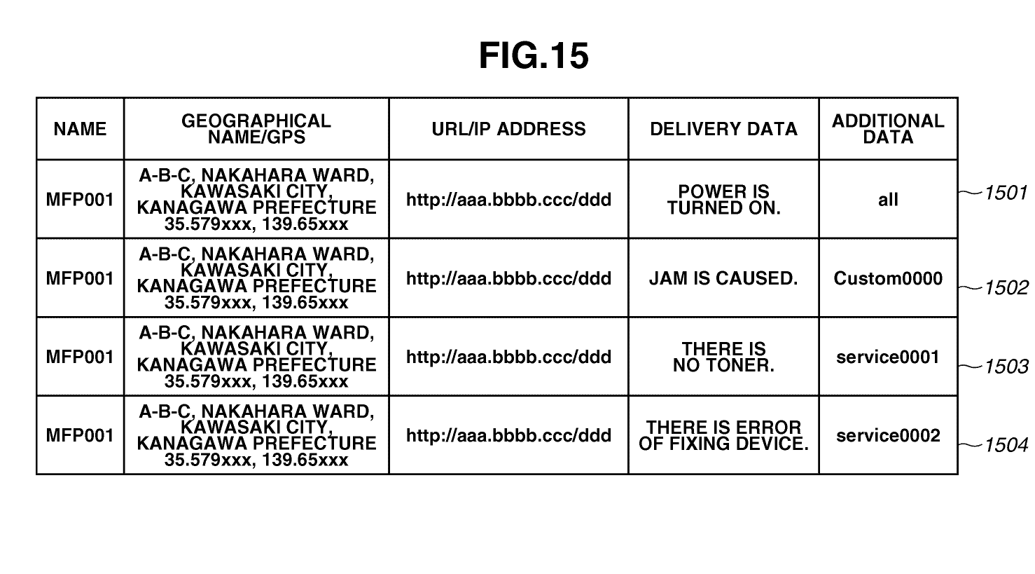

FIG. 15 illustrates example delivery data delivered from the image forming apparatus to delivery destination 1 in step S1304 in FIG. 13. FIG. 15 illustrates sequential delivery of delivery data 1501 to 1504. Each of the delivery data 1501 to 1504 includes the identification name (name) 901, the positional information (geographical name/GPS) 902, the URL/IP address 903, the delivery data 904, and the additional data 905.

Since the delivery data 1502 to 1504 is transmitted also to the external servers, special IDs “0000” to “0002” are added in the additional data 905 such as “custom0000,” “service0001,” and “service0002.” The ID may also be added to all data.

After completing step in S1304, the CPU 102 causes the operation to proceed to step S1305. In step S1305, the CPU 102 checks whether any external server needs to be notified. Namely, the CPU 102 checks the event detected in step S1302 with respect to the setting of the registration information (setting (FIG. 14) in S1301), to check (determine) whether an external server needs to be notified.

For example, if the CPU 102 detects “JAM” as the event, the CPU 102 determines that an external server needs to be notified. If the CPU 102 detects “PRINT OK” as the event, the CPU 102 determines that no external server needs to be notified.

If the CPU 102 determines that an external server needs to be notified of the event detected in step S1302 (YES in step S1305), the CPU 102 causes the operation to proceed to step S1306. However, if the CPU 102 determines that no external server needs to be notified of the event detected in step S1302 (NO in step S1305), the CPU 102 causes the operation to proceed to step S1307.

In step S1306, the CPU 102 creates data to be transmitted to an external server (server 2 (500)) on the RAM 104 and transmits the created data to an external server transmission destination set in the storage device 105 via the network unit 106 and the Internet 200. In this step, the CPU 102 accesses the server 2 (500) via the network unit 106 by using the https protocol.

In addition to the data transmitted to the delivery destination (server 300) in step S1304, the data transmitted from the CPU 102 includes certain management information (consumable supply (toner, paper) remaining amounts, a total print counter value, CO2 emission, power consumption, etc., in addition to various types of error information such as error codes). Such data is transmitted in a format for accessing the external server (server 2 (500)). The data may be completely different from the delivery data transmitted to the server 300 in step S1304. However, to associate the data with the above delivery data, at least the above special ID needs to be included in the additional data 905.

After completing step S1306, the CPU 102 causes the operation to proceed to step 51307. In step S1307 (detailed data transmission determination step), the CPU 102 refers to the events set in FIG. 14 to check (determine) whether detailed data about the event needs to be transmitted. If the event detected in step S1302 is an event whose detailed data needs to be transmitted (YES in step S1307), the CPU 102 causes the operation to proceed to step S1308. On the other hand, if the CPU 102 determines that the event detected in step S1302 is not an event whose detailed data needs to be transmitted to an external server (NO in step S1307), the CPU 102 causes the operation to proceed to END.

In step S1308 (detailed data transmission step), the CPU 102 creates detailed data on the RAM 104 and transmits the created data to a detailed data transmission destination (server 3 (600)) set in the storage device 105 via the network unit 106 and the Internet 200.

The detailed data is set in advance in the storage device 105 of the image forming apparatus 100 per event. More specifically, for example, the detailed data is various types of setting data of the image forming apparatus 100 or log information created by a program executed in the image forming apparatus 100.

Before transmitting the detailed data, the CPU 102 adds the special ID added in the additional data 905 in step S1304 or S1306, to the detailed data. In this way, the data transmitted in step S1304 or S1306 and the data transmitted in step S1308 can be associated with each other.

As described above, in the second exemplary embodiment, the CPU 102 of the image forming apparatus 100 not only posts data on the short sentence communication service provided by the server 300 but also outputs messages corresponding to the data based on the type of the acquired event, to other server apparatuses (server 2 (500) and server 3 (600)) different from the server 300, by using a transfer method different from that used for posting the data on the short sentence communication service. The data may be transmitted to the server 2 (500) or the server 3 (600) by another method such as electronic mail.

### Effect of Second Exemplary Embodiment

As described above, according to the second exemplary embodiment, data delivered (posted) by the image forming apparatus 100 to the short sentence communication service or detailed data relating to the data can also be delivered to existing image forming apparatus services (the server 2 (500) or the server 3 (600) as the external servers). As a result, in addition to the effect of the first exemplary embodiment, the image forming apparatus can be managed more easily.

Next, a third exemplary embodiment will be described based on the system according to the first or second exemplary embodiment. In the third exemplary embodiment, based on data transmitted from the image forming apparatus 100, a server transmits data including a command to the image forming apparatus 100. Based on the command included in the received data, the image forming apparatus 100 executes processing.

### Data Reception Process

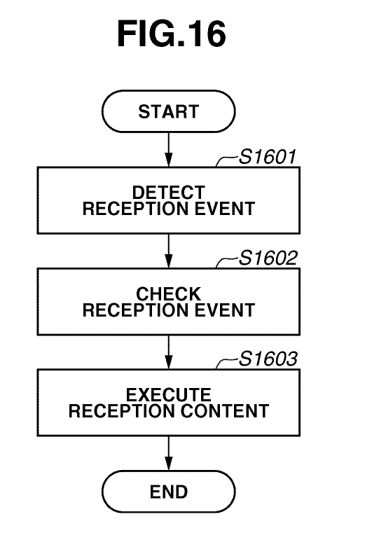

Next, a data reception process according to the third exemplary embodiment will be described. FIG. 16 is a flowchart illustrating an information reception process according to the third exemplary embodiment of the present invention. Each of the steps in the flow chart in FIG. 16 is realized by causing the CPU 102 of the image forming apparatus 100 to execute a computer-readable program recorded in the storage device 105.

First, in step S1601 (reception event detection step), the CPU 102 uses an account corresponding to delivery destination 1 or 2 to log in the short sentence communication service, detects a reception event supplied from the server 300 to the network unit 106 via the Internet 200, and transmits the detected event to the RAM 104.

In the short sentence communication service provided by the server 300, a user can use functions such as “reply” for replying to delivery data received by the information processing terminal 400 and “retweet” for introducing the received delivery data to his/her own followers (users following the user) with the addition of his/her own data. If a user uses the function “retweet,” the information processing terminal 400 transmits the retweet data not only to his/her followers but also to the user who has delivered the original data.

When a user operates the information processing terminal 400 and uses a function such as “reply,” “retweet,” or “direct message” with respect to delivery data from the image forming apparatus 100, a reception event directed to the image forming apparatus 100 is caused. In addition, in the short sentence communication service, there is a function of transmitting mail indicating that a reception event corresponding to the function such as “reply” or “retweet” is caused. Thus, the image forming apparatus 100 maybe configured to detect a reception event caused by the above function “reply” or “retweet” when receiving such notification mail.

By using the above function such as “reply” or “retweet,” it is possible to cause the image forming apparatus 100 to execute the following operation. For example, if a serviceman recognizes delivery data corresponding to a service error on the information processing terminal 400, the serviceman uses the function such as “reply” or “retweet” with respect to the delivery data, to post text data including a command for resolving the service error to an account of delivery destination 1 or 2. Subsequently, by using the account of delivery destination 1 or 2 and logging in the short sentence communication service, the image forming apparatus 100 can detect the reception event and receive the data including the command from the server 300.

Namely, in step S1601, the image forming apparatus 100 detects a message “retweeted” based on a message posted by the image forming apparatus 100 via a certain account (detects a message posted via another account associated with the certain account by the follow function) and acquires the message from the server 300 (message acquisition process).

Next, in step S1602 (detected event check step), about the reception event detected in step S1601, the CPU 102 determines whether the command included in the data transmitted from the server 300 is a preset command.

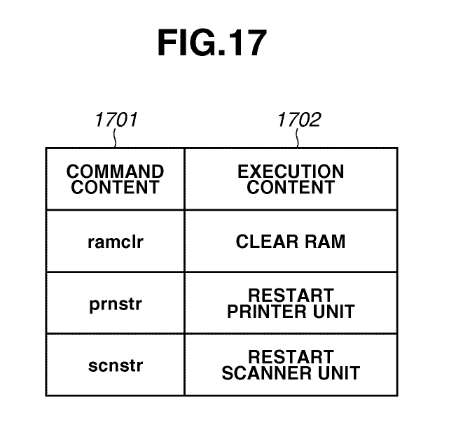

FIG. 17 illustrates an example preset command table. This table is preset and stored in the storage device 105 of the image forming apparatus 100. FIG. 17 illustrates commands 1701 included in the data transmitted from the server 300. In addition, FIG. 17 illustrates contents 1702 that correspond to the respective commands 1701 and that are executed by the CPU 102 in the image forming apparatus 100.

In step S1602, if the CPU 102 determines that the command included in the data transmitted from the server 300 is a preset command (FIG. 17), the CPU 102 causes the operation to proceed to step S1603.

However, in step S1602, if the CPU 102 determines that the command included in the data transmitted from the server 300 is not a preset command (1701 in FIG. 17), the CPU 102 causes the operation to proceed to END. This loop is not illustrated in the flow chart in FIG. 16.

In step S1603, the CPU 102 executes an execution content (1702 in FIG. 17) corresponding to the command (1701 in FIG. 17) included in the data transmitted from the server 300. If the execution content involves the scanner unit 108 or the printer unit 109 based on the execution content, the CPU 102 gives an instruction to the CPU 131 of the scanner unit 108 or the CPU 151 of the printer unit 109. Accordingly, the CPU 131 of the scanner unit 108 or the CPU 151 of the printer unit 109 causes the scanner unit 108 or the printer unit 109 to execute a predetermined operation corresponding to the above instruction.

For example, if the command content is “ramclr,” the CPU 102 clears the RAM 104. If the command content is “prnstr,” the CPU 102 gives an instruction for restarting the printer unit 109 to the CPU 151 of the printer unit 109. In accordance with the instruction, the CPU 151 of the printer unit 109 restarts the printer unit 109. If the command content is “scnstr,” the CPU 102 gives an instruction for restarting the scanner unit 108 to the CPU 131 of the scanner unit 108. In accordance with the instruction, the CPU 131 of the scanner unit 108 restarts the scanner unit 108.

If the system according to the second exemplary embodiment is used, the reception event detected in step S1601 is not limited to a reception event from the server 300, but may also be a reception event from the server 2 (500), or the server 3 (600). If this configuration is used, for example, a manager or a serviceman transmits data including a command to the image forming apparatus 100 from the server 2 (500) or the server 3 (600).

In the short sentence communication service, other than the above functions “reply” or “retweet,” the function called “direct message” can be used for transmitting a message to a specific account. A command can be transmitted to the image forming apparatus 100 by using this “direct message” function and transmitting a message including the command to an account corresponding to delivery destination 1 or 2.

### Effect of Third Exemplary Embodiment

According to the third exemplary embodiment, based on data transmitted from the image forming apparatus 100, a server transmits data including a command to the image forming apparatus 100, and the image forming apparatus 100 executes processing in accordance with the command included in the received data. As a result, in addition to the effects of the first and second exemplary embodiments, the image forming apparatus can be managed more easily.

As described above, according to the present exemplary embodiment, the image forming apparatus can select suitable delivery destinations depending on information about the image forming apparatus and can deliver the information to the selected delivery destinations. Thus, information delivered from the image forming apparatus can be grouped easily. In this way, certain users such as managers and servicemen can recognize detailed information while general users can easily recognize general information. Namely, since various users can easily grasp the state of the image forming apparatus at the respective positions, the image forming apparatus can be managed easily.

In addition, in association with existing services surrounding image forming apparatuses such as short sentence communication services, managers, servicemen, and users can manage the image forming apparatuses more easily.

In addition, by associating information transmitted to an existing service with information transmitted to other server apparatuses (monitoring servers such as the servers 2 and 3) managing an image forming apparatus by use of an ID, the existing services and the monitoring server of the image forming apparatus can easily be coordinated.

The configurations and contents of the above data according to the present invention are not limited to those described above. The data may have various configurations or contents, depending on the use or the purpose. While exemplary embodiments have been described, the present invention can be realized in various modes, for example, as a system, an apparatus, a method, a program, or a storage medium. More specifically, the present invention can be applied to a system including a plurality of devices or to an apparatus consisting of a single device. In addition, the present invention includes any combination of the above exemplary embodiments.

### Other Embodiments

Aspects of the present invention can also be realized by a computer of a system or apparatus (or devices such as a CPU or MPU) that reads out and executes a program recorded on a memory device to perform the functions of the above-described embodiment(s), and by a method, the steps of which are performed by a computer of a system or apparatus by, for example, reading out and executing a program recorded on a memory device to perform the functions of the above-described embodiment(s). For this purpose, the program is provided to the computer for example via a network or from a recording medium of various types serving as the memory device (e.g., computer-readable medium).

While the present invention has been described with reference to exemplary embodiments, it is to be understood that the invention is not limited to the disclosed exemplary embodiments. The scope of the following claims is to be accorded the broadest interpretation so as to encompass all modifications, equivalent structures, and functions.

This application claims priority from Japanese Patent Application No. 2012-034693 filed Feb. 21, 2012, which is hereby incorporated by reference herein in its entirety.

What is claimed is:

1. A management system, comprising:
a server apparatus; and
an image forming apparatus,
wherein the server apparatus comprises:
a management unit configured to manage posted messages per account; and
a providing unit configured to provide an information service that displays the managed messages, and
wherein the image forming apparatus comprises:
an event acquisition unit configured to acquire an event of the image forming apparatus;
a determination unit configured to determine one or a plurality of output targets to which data according to the event is output, based on a type of the acquired event; and
an output unit configured to post a message corresponding to data based on a type of the acquired event, on the information service provided by a server apparatus as an output target determined by the determination unit, by using a plurality of accounts.

2. A management system, comprising:
a plurality of server apparatuses including a first server apparatus; and
an image forming apparatus,
wherein the first server apparatus comprises:
a management unit configured to manage posted messages per account; and
a providing unit configured to provide an information service that displays the managed messages,
wherein the image forming apparatus comprises:
an event acquisition unit configured to acquire an event of the image forming apparatus;
a determination unit configured to determine a plurality of output targets to which data according to the event is output, based on a type of the acquired event; and
an output unit configured to post a message corresponding to data based on a type of the acquired event, on the information service provided by the first server apparatus as an output target determined by the determination unit, by using one or a plurality of accounts, and
wherein the output unit outputs a message corresponding to data based on a type of the acquired event, on another server apparatus different from the first server apparatus as an output target determined by the determination unit, by using a transfer method different from that used for posting on the information service.

3. An image forming apparatus capable of communicating with a server apparatus that provides an information service of managing posted messages per account and displaying the messages on a browse page, the image forming apparatus comprising:
an event acquisition unit configured to acquire an event of the image forming apparatus;
a determination unit configured to determine one or a plurality of output targets to which data according to the event is output, based on a type of the acquired event; and
an output unit configured to post a message corresponding to data based on a type of the acquired event, on the information service provided by a server apparatus as an output target determined by the determination unit, by using a plurality of accounts.

4. The image forming apparatus according to claim 3, further comprising:
a setting unit configured to set an account used when a message is posted on the information service per event type.

5. The image forming apparatus according to claim 4,
wherein the setting unit sets a level used when posting a message on the information service per event type, and
wherein the output unit posts a message including a content based on the set level.

6. The image forming apparatus according to claim 3, further comprising:
a message acquisition unit configured to acquire a message posted by using another account from the server apparatus, the message relating to a message posted by the output unit; and
an execution unit configured to execute, if the acquired message includes a certain command, a process corresponding to the command.

7. The image forming apparatus according to claim 3,
wherein a message posted by the output unit includes positional information about the image forming apparatus.

8. An image forming apparatus capable of communicating with a server apparatus that provides an information service of managing posted messages per account and displaying the messages on a browse page and at least one server apparatus different from the server apparatus, the image forming apparatus comprising:
an event acquisition unit configured to acquire an event of the image forming apparatus;
a determination unit configured to determine a plurality of output targets to which data according to the event is output, based on a type of the acquired event; and
an output unit configured to post a message corresponding to data based on a type of the acquired event, on the information service provided by a server apparatus as an output target determined by the determination unit, by using one or a plurality of accounts,
wherein the output unit outputs a message corresponding to data based on a type of the acquired event, to the different server apparatus as an output target determined by the determination unit, by using a transfer method different from that used for posting on the information service.

9. The image forming apparatus according to claim 8, wherein the output unit outputs a different message content, depending on the output target.

10. The image forming apparatus according to claim 8, wherein the output unit outputs an error code or log information about the acquired event, to the different server apparatus.

11. A control method for an image forming apparatus capable of communicating with a server apparatus that provides an information service of managing posted messages per account and displaying the messages on a browse page, the control method comprising:
acquiring an event of the image forming apparatus;
determining one or a plurality of output targets to which data according to the event is output, based on a type of the acquired event; and
posting a message corresponding to data based on a type of the acquired event, on the information service provided by a server apparatus as the determined output target, by using a plurality of accounts.

12. A control method for an image forming apparatus capable of communicating with a server apparatus that provides an information service of managing posted messages per account and displaying the messages on a browse page and at least one different server apparatus from the server apparatus, the control method comprising:
acquiring an event of the image forming apparatus;
determining a plurality of output targets to which data according to the event is output, based on a type of the acquired event; and
posting a message corresponding to data based on a type of the acquired event, on the information service provided by a server apparatus as the determined output target, by using one or a plurality of accounts,
wherein, in the posting of a message, the message corresponding to data based on a type of the acquired event is output to the different server apparatus as the determined output target, by using a transfer method different from that used for posting on the information service.

13. A computer-readable storage medium storing a computer program for causing a computer to execute a control method for an image forming apparatus capable of communicating a server apparatus that provides an information service of managing posted messages per account and displaying the messages on a browse page, the control method comprising:
acquiring an event of the image forming apparatus;
determining one or a plurality of output targets to which data according to the event is output, based on a type of the acquired event; and
posting a message corresponding to data based on a type of the acquired event, on the information service provided by a server apparatus as the determined output target, by using a plurality of accounts.

14. A computer-readable storage medium storing a computer program for causing a computer to execute a control method for an image forming apparatus capable of communicating with a server apparatus that provides an information service of managing posted messages per account and displaying the messages on a browse page and at least one different server apparatus from the server apparatus, the control method comprising:
acquiring an event of the image forming apparatus;
determining a plurality of output targets to which data according to the event is output, based on a type of the acquired event; and
posting a message corresponding to data based on a type of the acquired event, on the information service provided by a server apparatus as the determined output target, by using one or a plurality of accounts,
wherein, in the posting of the message, a message corresponding to data based on a type of the acquired event is output to the different server apparatus as the determined output target, by using a transfer method different from that used for posting on the information service.
